(19) United States
(12) Patent Application Publication
(10) Pub. No.: US 2007/0216153 A1
(43) Pub. Date: Sep. 20, 2007

(54) Bound book having hardcover and method of making same

(76) Inventors: Kevin P. Parker, Berkeley, CA (US); John Calvin Barthel, Albany, CA (US)

Correspondence Address: GIRARD & EQUITZ LLP;Attn: Philip A. Girard, Suite 1110, 400 Montgomery Street, San Francisco, CA, 94104, US

(21) Appl. No.: 11/369,180

(22) Filed: Mar. 6, 2006

(51) Int. Cl. B42D 1/00

(52) U.S. Cl. 281/21.1

(57) ABSTRACT

A stitched hardcover book and method of making same wherein the stitching is at least partly concealed. A stack of sheets to be bound is disposed intermediate first and second end leafs, with each of the end leafs including an attached reinforcing strip extending along an edge of the end leaf. The combined assembly is provided with stitching which extends through the stack and the reinforcing strips. The first and second end leafs are secured to an inner surface of respective first and second covers of a hardcover assembly, with the components of the hardcover book being configured such that when the first and second cover sections are positioned in a common plane, a bound end of the sheets of the stack is disposed on a first side of the common plane, with the sheets extending to an opposite second side of the common plane and with the stitching line being disposed on said first side of the plane. The reinforcing strips tend to ensure this configuration so that the stitching is substantially concealed from view.

### BACKGROUND OF THE INVENTION

1. Field of the Invention

The present invention relates generally to the field of bookbinding and, in particular, a bound hardcover book and method of making same suitable for fabrication using desktop equipment.

2. Description of Related Art

Binding systems for binding stacks of sheets into a book using desktop equipment have increased in popularity. One popular system uses a binder strip having and adhesive surface, such as disclosed in U.S. Pat. No. 4,496,617, with the contents of this patent being fully incorporated into the present application by reference. The binder strip is typically applied to a stack of sheets to be bound using a desktop binding machine such as disclosed in U.S. Pat. No. 5,052,873, with the contents of this patent also being fully incorporated into the present application by reference. The binding machine carries out the binding operation by suitably positioning the binder strip relative to the stack to be bound and applying heat and pressure so that the edges of the stack are bound. The bound stack is then preferably encased in a hardcover, also using desktop equipment in accordance with the prior art as will be described below.

The thermal binder strips used for binding the stack of sheets prior to application of the hardcover usually provide a very reliable bind. However, in a few cases where coated papers are used, thermal binding can be less reliable. One solution is to condition the sheets of the stack prior to binding. However, there is a requirement for binding coated sheets and encasing the book in a hardcover using where such conditioning is not possible or convenient. The present invention addresses these issues, with the following description of one prior art approach being useful in showing the advantages of the present invention in the instances where coated paper is to be bound and sheet conditioning is not utilized.

Referring to the drawings, FIG. 1 shows a stack of sheets 15 to be bound and then encased in a hardcover assembly in accordance with the prior art. A first folded liner sheet 12, forming sheets 12A and 12B the same size as the sheets to be bound and separated by a fold 12C is provided. Folded liner sheet 12 is positioned on the top of the stack 15 with a second similar folded liner sheet 14, forming sheets 14A and 14B, being positioned on the bottom of the stack. The liner sheets 12 and 14 are preferably of a relatively heavy stock as compared to the sheets 15 to be bound. Once the liner sheets 12, 14 and stack of sheets 15 have been assembled, the combined stack 10 is bound together using a conventional binder strip 16 as described in the above-noted U.S. Pat. No. 4,496,617. The actual binding is preferably is carried out using a desktop binding machine as described in the above-noted U.S. Pat. No. 5,052,873. The bound stack 10 is shown in FIG. 2, with the adhesive present in the binder strip 16 operating to bind the individual sheets together and to the heavy paper substrate of the binder strip 16.

FIG. 3 shows details of a prior art hardcover assembly 18 that is to be applied to the bound stack 10 of FIG. 2. Typically, the cover assembly 18 is completely assembled and sold separately to the user. As will be described, the cover assembly 18 can be manufactured in various sizes to accommodate differing sheet sizes and stack 10 sizes in terms of stack thickness. It is further anticipated that a user can request that certain information be preprinted on the assembly 18, including title information and any other graphics. As will be described, hardcover assembly 18 includes relatively rigid front and back cover sections 18A and 18B, respectively, separated by a relatively flexible spine section 18C.

The cover assembly 18 includes a pair of relatively stiff cover boards 24A and 24B made of cardboard or the like. The cover boards 24A and 24B are typically 8⅜ inches by 11¼ inches for binding 8½ by 11 inch stack 10. The cover boards are covered with a flexible cover membrane 22, typically fabric, which is folded around the edges of the cover boards, as depicted in FIG. 3. That part of the cover membrane 22 disposed intermediate the opposite edges 25A and 25B of the cover boards is unsupported and is thus relatively flexible. A length 29 (not depicted in FIG. 3) of fabric or stiff paper, typically 0.010 inches thick, is preferably disposed on the spine section 26 of the hardcover assembly 18 so as to slightly stiffen the membrane 22 in that location so that a desired shape is achieved when the bound book is opened and closed. The membrane regions 28A and 28B disposed between the respective edges of the spine section 26 (or, if used, the respective edges of the spine stiffening member to be disposed over the spine section 26) and the respective edges 25A and 25B of the cover boards 24A and 24B are referred to as gutter regions. The gutter regions 28A and 28B are each fixed in width at ⅜ of an inch. The gutter regions define the flexible portion of the cover membrane. Alternatively, a spine board 24C (not depicted in FIG. 3), made of the same material as the cover boards 24A and 24B and having a shape that generally corresponds to the spine region 26, can be used. The spine board, which is typically 0.088 inches thick, functions to stiffen the spine 26, with spine flexibility being provided by the flexible gutter regions 28A and 28B disposed between the respective edges of the cover boards 24A and 24B and the respective edges of the spine board. When the spine board 24C is used, the gutter region 28A and 28B widths are preferably increased slightly to 7/16 of an inch.

The spine region 26 width varies, along with the width of the spine board if one is used, depending upon the width of the stack 10 to be bound. The cover assemblies are preferably prefabricated in various widths to accommodate stacks 10 of various widths as set forth below in Table 1.

TABLE 1

| | Spine 26 | Stack |
|---|---|---|
| | Width | Thickness |
| Model | (inches) | (inches) |
| A | ⅜ | To ¼ |
| B | ½ | ¼ to ½ |
| C | ¾ | ½ to ¾ |
| D | 1 | ¾ to 1 |
| E | 1¼ | 1 to 1¼ |
| F | 1½ | 1¼ to 1½ |

The number of available spine widths can be increased or decreased from the values set forth above in Table 1, with a larger number increasing the difficulty of maintaining an adequate inventory and a smaller number detracting somewhat from the appearance of the final product in the spine region.

Referring back to FIG. 3, the cover assembly 18 is prefabricated using a pair of pressure sensitive adhesive sheets structure 30A and 30B. Further details of the adhesive sheets are also shown in FIGS. 4 and 5. Adhesive sheet structures 30A and 30B are dimensioned approximately 8¼ by 10¾ inches when the stack 10 size is 8½ by 11 inches, to cover the interior periphery of the folded portions of the cover membrane 22A and 22B and to further secure the periphery of the membrane to the respective cover boards 24A and 24B. The smaller size of the underlying sheets 32A and 32B of the sheet structure ensures that the folded liner sheets 12A and 14A completely cover sheets 32A and 32B despite any small misalignment. Each sheet structure 30A/30B includes respective bottom sheets 32A and 32B and respective upper major release liner 36A and 36B. A respective layer of pressure sensitive adhesive 34A and 34B is disposed intermediate that upper liner and bottom sheet. A pressure sensitive adhesive manufactured by National Starch and Chemical Company and marketed under the designation Instant-Lok, type HL PSA 20-81, has been found suitable for this application. The adhesive layers 34A and 34B are preferably 0.003 to 0.004 inches in thickness.

The upper major release liners 36A and 36B are disposed over a majority of the underlying pressure sensitive adhesive layers. Generally, at least 75% of the adhesive layers are covered by the respective upper major release liners 36A and 36B, with a remaining strip of the adhesive along the inner edge of the sheet structures not being covered by the major release liners 36A and 36B. Instead, upper minor release liners 38A and 38B are disposed over the exposed adhesive strips. This relationship is shown schematically in FIG. 5 (not to scale) for adhesive sheet structure 30B where only a portion of the sheet structure is depicted. As can be seen, the pressure sensitive adhesive layer 34B is disposed between the bottom sheet 32B and upper major and minor release liners 36B and 38B. That portion of the adhesive layer 34B not covered by the upper major release liner 36 is covered by a separate upper minor release liner 38B. The minor release liner 38B is actually positioned contacting the adhesive layer 34B and is secured in place by the adhesive layer. As is well known, all of the release liners 36A, 38A, 36B and 38B are fabricated from a material that only slightly adheres to the pressure sensitive adhesive so that the release liners can be manually separated from the adhesive without damage to the adhesive or the release liners. As part of the prefabrication of the hardcover assembly, conventional case glue 55 (not depicted in FIGS. 4 and 5) is applied to the top of the cover sections 18A and 18B and to the bottom sheets 32A and 32B. The sheet structures are then positioned over the respective cover sections 18A and 18B as shown in FIG. 3 so that the sheet structures will be secured to the cover sections by the case glue. Thus, the sheet structures 30A and 30B are secured to the cover boards 24A and 24B and to the peripheral portions of the cover membrane 22 by way of the case glue. This completes the prefabrication of the prior art hardcover assembly 18.

Referring now to FIGS. 6 and 7, a prior art guide apparatus 40 is disclosed for use in carrying out the process for encasing the bound stack in the hardcover assembly 18. The guide apparatus includes a flat base member having a receiving surface 42 that is somewhat larger that the largest book to be bound when the book is in the open position. A stop member 44 having two orthogonal segments is supported on the upper surface 42 of the base member and extends around two adjacent sides of the base member. A ledge member 46, also having two orthogonal segments, is supported above the stop member 44 and, as can be in FIG. 7, have outer edges 46A which extend past the edge 44A of the stop member a small distance X, with the overhang being typically 0.14 inches. The height of the ledge member above the support surface is great enough to accommodate the thickness of the cover sections 18A and 18B of the cover assembly 18. The ledge member 46 extends along stop member 44 in one direction a distance Y (FIG. 6) which is somewhat smaller than the closed width of the smallest book to be bound. The distance Z, the distance that the ledge member 46 extends along stop member 44 in the other direction, is typically about twice dimension Y.

The guide apparatus 40 also preferably includes two or more vertical stop members, such as 48A, 48B and 48C, with vertical stop member 48A being supported on ledge member 46 about one third of the distance Y of the ledge member from the corner formed by the intersection of the two ledge member 46 segments. Vertical stop member 48B and 48C are at approximate equal distances along the other ledge member 46 segment. As can best be seen in FIG. 7, the vertical stop members each have a planar surface, surface 50C for example, that coincides with the inner edge, edge 44A for example, of the stop member. This configuration also applies to the planar surfaces 50A and 50B of vertical stop members 48A and 48B.

The prior art sequence for encasing the bound stack in the hardcover assembly 18 will now be described, starting with reference to FIG. 8A. The opened hardcover assembly 18 is first positioned on the guide apparatus receiving surface 42, with the upper release liners 36A and 36B facing upwards. As indicated by arrow 52, the hardcover assembly is moved along the surface 42 of the guide apparatus until the edges of cover section 18B is positioned under the ledge member 46, abutting the inner edge 44A of the stop member 44, as shown in FIG. 7. Thus, the outer edge 46A of the ledge member 46 will be positioned a fixed distance X from the edge of cover 18B along the full length of both orthogonal segments of the ledge member 46. The outer edge 46A will provide a guide for positioning the bound stack 10, as will be described.

Once the hardcover assembly 18 is properly positioned on the guide apparatus 40, the user manually separates the upper minor release liner 38B as shown in FIG. 8B from the assembly 18. This will expose a relatively narrow strip of the underlying pressure sensitive adhesive 34B adjacent spine region 26. Next, the bound stack 10 is placed over the upper major release liner 36B, with the edges of the stack engaging edge 46A of the ledge member 46 along both orthogonal segments. FIG. 7 shows the edge of stack 10 engaging edge 46A along one of the two segments. As shown in FIG. 8C by arrows 52, that portion of stack 10 along the exposed adhesive 34B is not placed on the exposed adhesive until the orthogonal edges of the stack are positioned against edge 46A of both segments. Once the correct position is achieved, the stack is forced down upon the exposed pressure sensitive adhesive 34B as shown in FIG. 8D. This operates to secure the folded liner sheet 14A of stack 10 to cover section 18B of the hardcover assembly 18 in a correctly aligned position.

The next step is to secure the remainder of the folded liner sheet 14A of stack 10 to the adhesive 34B of assembly 18. Referring to FIG. 8E, the free edge of stack 10, including liner sheet 14A, is lifted up and rotated away from the upper major release liner 36B. This permits the release liner 36B to be separated from the hardcover assembly 18 thereby exposing the remainder of the pressure sensitive adhesive 34B. As shown in FIG. 8F, the spine portion of stack 10 held down against the hardcover assembly 18 with one hand while stack 10 is rotated over the adhesive 34B with the other hand. As shown in FIG. 8G, the user then presses the stack 10 down on the hardcover assembly 18. This causes the remainder of the liner sheet 14A of the stack to be secured by the remainder of adhesive 34B to cover section 18B of the hardcover assembly 18. The second cover section 18A of the hardcover assembly will now be attached.

Referring to FIG. 8H, the upper minor release liner 38A is next separated from the hardcover assembly 18 thereby exposing a strip of pressure sensitive adhesive 34A adjacent spine region 26. Although not depicted, the upper major release liner 36A is then also separated from the hardcover assembly 18 thereby exposing the remainder of the pressure sensitive adhesive layer 34A. The user then lifts the cover section 18A of the hardcover assembly away from the surface 42 of the guide apparatus and rotates the cover 18A around the spine. As indicated by arrows 54 of FIG. 8I, the cover section 18A is positioned so that the edges of the cover section 18A contact the planar surfaces 50A, 50B and 50C of the respective three vertical stop members 48A, 48B and 48C. This is shown in phantom in FIG. 7. The hardcover assembly 18 is then positioned correctly with respect to the bound stack 10. The user then presses down on cover section 18A as shown in FIG. 8J over the entire surface of the cover section thereby securing the cover section to the folded liner sheet 12A of stack 10. Note that this action results in the book block 74 being arranged relative to cover board 24A and spine board 24C with the same dimensions D, E, F and G as set forth in Table 2 as is the book block relative to cover section 24B and spine board 24C shown in FIG. 11. In other words, the book block 74 is symmetrically arranged relative to the cover boards 24A and 24B and the spine board 24C. This completes the binding sequence.

FIGS. 9A and 9B show the completed book in a closed position. FIG. 10 shows a prior art book similar to FIGS. 9A and 9B except that the previously noted spine board 24C, hidden behind the membrane of the spine section 18C is used. The book is shown in a completely open position with the downward gravitational force exerted on the cover sections 18A and 18B tending to pull the binder strip 16 edges apart, with this tension force on the binder strip 16 tending to hold the bound end of the stack up and out of the spine cavity 19. The FIG. 9A and 9B books have a similar tendency. In order to enhance the strength of the bind when coated sheets are being bound, the book could be stitched using string, staples or the like at a location of typically ⅛ of an inch from the end of the book (not depicted). Note that the term stitched as used in the present application is meant to encompass all kinds of binding where the sheets to be bound are provided with a plurality of openings extending along the edge of the spine through which a binding member extends such as string, metal staples, plastic studs and the like. It is apparent from FIG. 10 that any such stitching would be visible to a user. As will be apparent from the following Detailed Description of the Invention together with the drawings, the present invention successfully meets the requirement of providing a stitched bind which is not visible under normal usage and which can be carried out using conventional desktop binding equipment.

### SUMMARY OF THE INVENTION

A hardcover book and method of making same are disclosed. One embodiment of the book includes a hardcover assembly having first and second relatively rigid cover sections separated by a spine section. A stack of sheets to be bound is combined with first and second end leafs, with each of the end leafs including an attached reinforcing strip extending along an edge of the end leaf. Typically, the end leafs are the same size of the sheets of the stack. The stack of sheets are disposed intermediate the end leafs, with the end leafs and the stack forming a stack assembly and with the reinforcing strips located near an edge of the stack assembly to be bound.

Stitching is provided which extends through the stack and the reinforcing strips, with said stitching being disposed along a stitching line on the edge of the stack assembly, with the stitching line being substantially parallel to the edge of the stack assembly to be bound. The first end leaf is secured to an inner surface of the first cover section, with said second end leaf being secured to an inner surface of the second cover section. The components of the hardcover book are arranged such that when the first and second cover sections are positioned in a common plane, a bound end of the sheets of the stack is disposed on a first side of the common plane, with the sheets extending to an opposite second side of the common plane and with the stitching line being disposed on said first side of the plane. The presence of the reinforcing strips tend to ensure this configuration.

### BRIEF DESCRIPTION OF THE DRAWINGS

FIG. 1 is a perspective view of a stack of sheets to be bound, including the front and back folded liner sheets as per the prior art.

FIG. 2 is a perspective view of the stack of sheets of FIG. 1 after binding using a conventional binder strip as per the prior art.

FIG. 3 is a perspective exploded view of a prior art hardcover assembly, with the pressure sensitive front and rear sheets structures shown displaced from the remainder of the assembly.

FIG. 4 is a perspective view of one of the two prior art pressure sensitive adhesive sheet structures.

FIG. 5 is a cross-section elevational view of a portion of the adhesive sheet structure of FIG. 4.

FIG. 6 is a perspective view of a prior art the guide apparatus used to attach the hardcover assembly to the bound stack.

FIG. 7 is an expanded side view of a portion of the guide apparatus of FIG. 6 with a stack to be bound shown in position.

FIGS. 8A-83 depict a prior art process for assembling the hardcover book.

FIGS. 9A and 9B are perspective views of portions of the completed prior art hardcover book.

FIG. 10 is a perspective end view of the completed prior art hardcover book showing the location of the bound end of the book relative to the hinge cavity when the hardcover book is in a fully open position.

FIG. 11 is a schematic diagram illustrating the relative positions of selected components of a completed hardcover book.

FIG. 12 is a single sheet end leaf for use in a hardcover book in accordance with one embodiment of the present invention.

FIG. 13 is a schematic diagram of a stack of sheets and two single sheet end leafs disposed on opposite sides of the stack prior to binding in accordance with one embodiment of the present invention.

FIG. 14 is a schematic diagram of a stack of sheets and two single sheet end leafs disposed on each side of the stack prior to binding in accordance with another embodiment of the present invention.

FIG. 15 shows a stack of sheets, with end leafs, being stapled prior to application of the hardcover in accordance with one aspect of the present invention.

FIGS. 16A and 16B are perspective partial views of a stack of sheets incorporating a single sheet end leafs on opposite sides of the stack prior to application of a hardcover.

FIG. 17 is an end view of a bound stack with hardcover attached in accordance with the present invention.

FIG. 18 is an enlarged section of the bound stack of FIG. 17.

FIG. 19 is a perspective partial view of a stack of sheets incorporating a pair of single sheet end leafs on each side of the stack prior to application of a hardcover in accordance with one aspect of the present invention.

FIG. 20 is a perspective partial view of a stack of sheets incorporating a pair of single sheet end leafs one side of the stack and one single sheet end leaf on the other side prior to application of a hardcover in accordance with another aspect of the present invention.

FIG. 21 is a flow chart in accordance with the one embodiment of the present invention for making a hardcover book.

FIG. 22 is a simplified schematic diagram of a hardcover book bound in accordance with one aspect of the present invention, with the cover boards located in a common plane and with the stitching line disposed below that common plane.

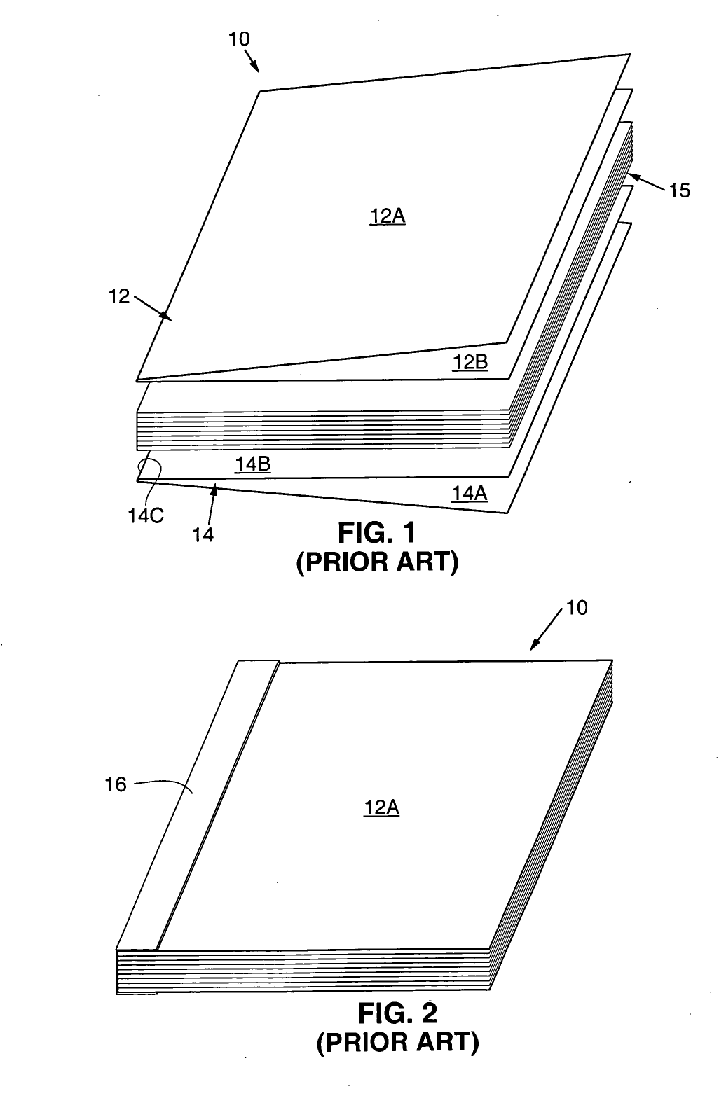

### DETAILED DESCRIPTION OF THE INVENTION

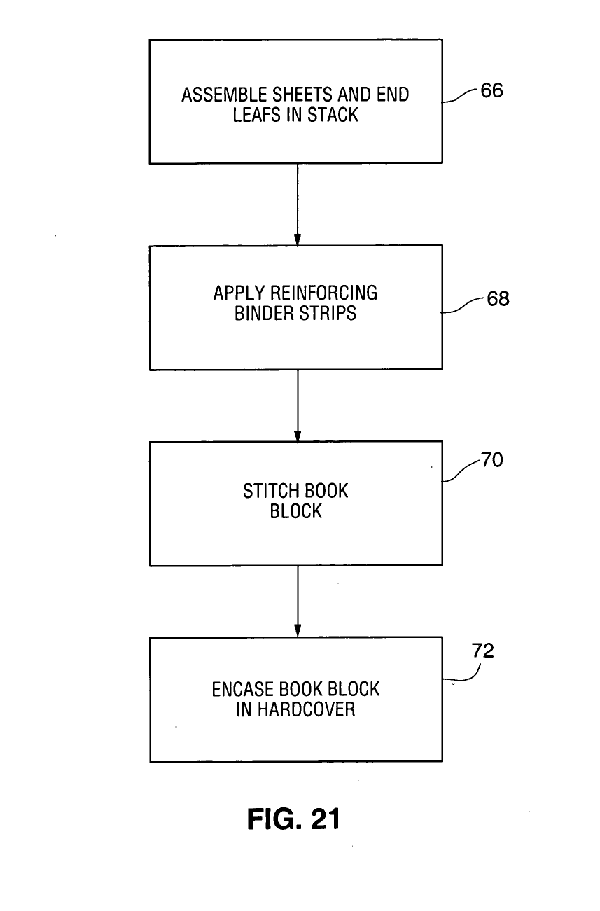

Referring again to the drawings, FIG. 21 is a simplified flow chart showing a method of making a hardcover book in accordance with one aspect of the present invention. As indicated by block 66 of the chart, the first step is to assemble the sheets to be bound, together with end leafs to be described, into a stack to form a stack assembly. Next, a reinforcing binder strip is applied to the edge of the stack assembly to be bound, typically using desktop binding equipment as indicated by block 68 of the chart. This creates a book block. As will be described, in the present application of the binder strip, the strip provides a reinforcement function and only a minimal binding function. Next, the book block is stitched using staples or the like as shown by block 70. Finally, as shown by block 72 the stitched book block is encased in a hardcover.

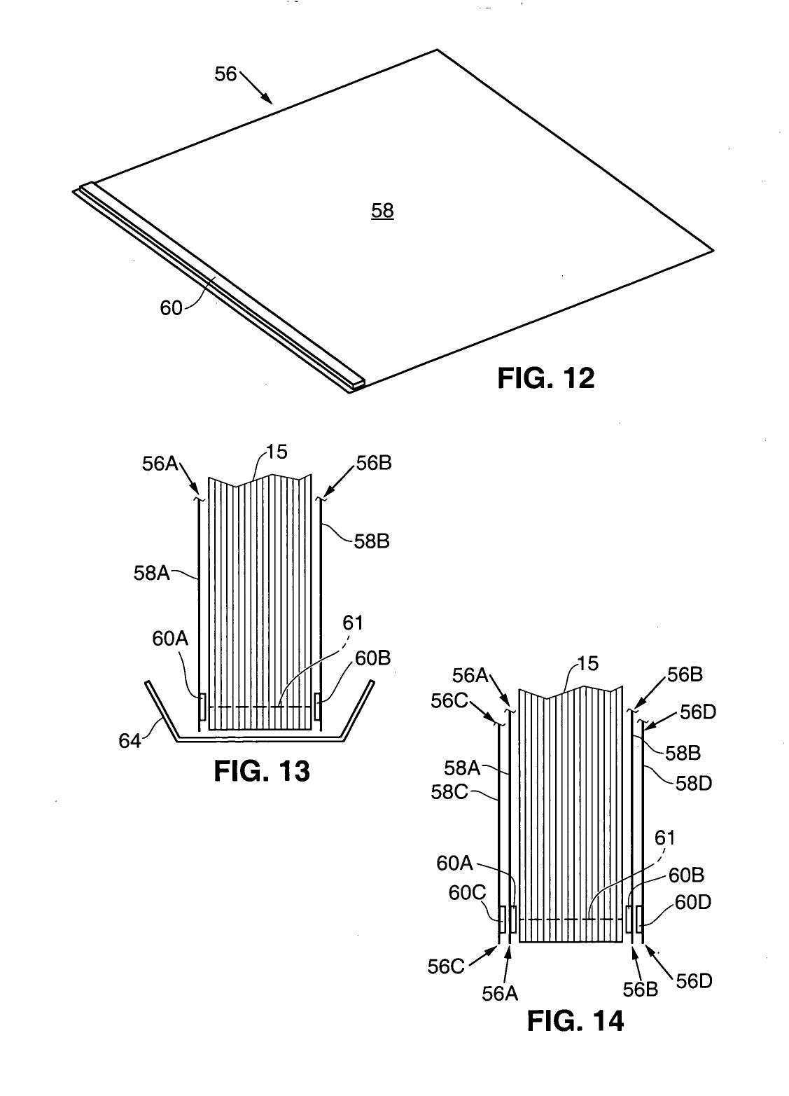

FIG. 12 shows a single sheet end leaf 56 for use in a bound book in accordance with one aspect of the present invention. The end leaf is typically made of a sheet 56 of heavy paper having the same general dimensions of the sheets of the stack being bound. A reinforcing strip 60 extends along one edge of sheet and is typically about 3/16 of an inch wide, 0.02 inches thick and the center line of the strip is displaced from the edge of the sheet by about ⅛ of an inch. Strip 60 is preferably made of a high tack temperature activated adhesive which is applied in a molten state so the strip is secured to the sheet 56. As will be described, stitching for binding the stack will extend along the center of the strip 60, with the primary functions of the strip to reinforce the sheet 58 of the end leaf, to provide support for the end leaf so that the sheet will tend to fold at the inner edge of the reinforcement strip and to assist in reinforcing the end leaf paper around the stitching.

In one embodiment, the bound book will include a pair of the single sheet end leafs 56 (56A/56B) as depicted in the diagram of FIG. 13. End leafs 56A and 56B are disposed on opposite sides of the stack of sheets 15, with the respective reinforcing adhesive strips 60A and 60B being positioned near the edge of the stack to be bound. Line 61, which represents the location of the stitching to be added later, is aligned with the center of each of the reinforcing strips 60A and 60B.

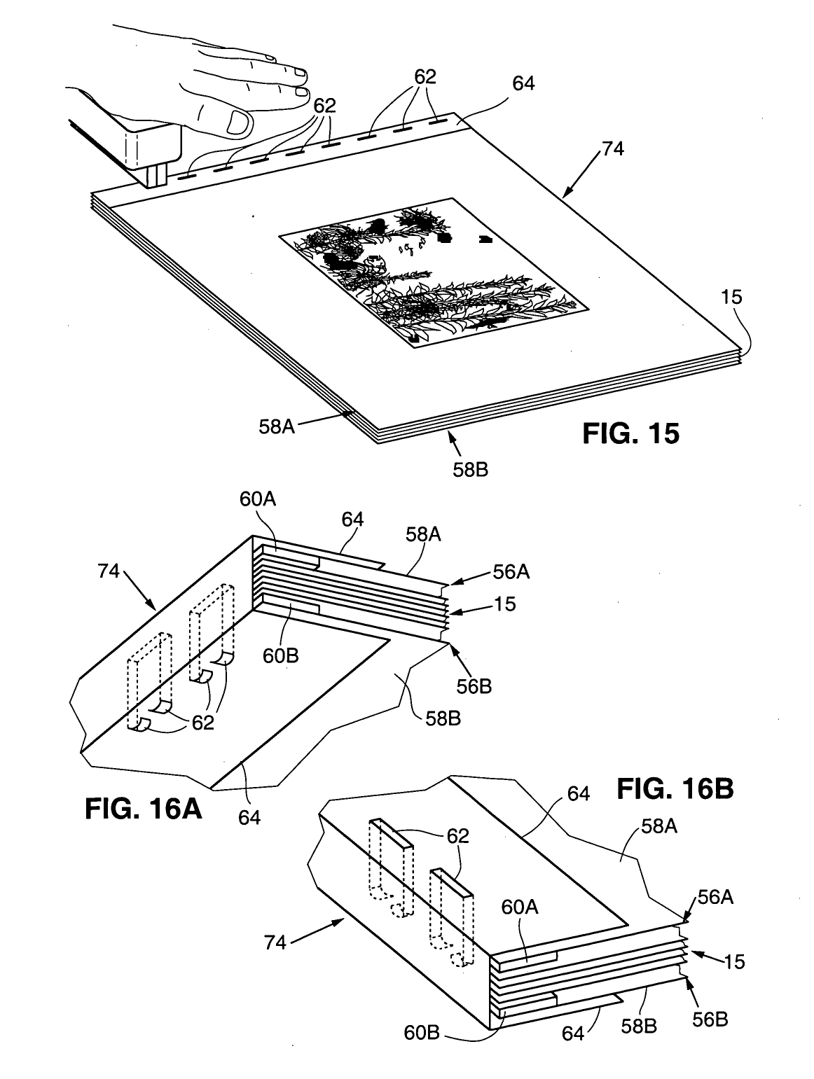

A specially adapted elongated binder strip 64 is then applied to the edge of the stack, preferably using a conventional desktop binding machine as indicated by block 68 of the FIG. 21 flow chart. This is carried out by inserting the stack assembly, which includes stack 15 and end leafs 56A and 56B together as a unit, into the binding machine, with the strip 64 being fed into the binder strip input of the binding machine. Binder strip 64 includes a substrate of heavy paper completely coated with a layer of high tack, high viscosity temperature activated adhesive in the inner surface. This is the same adhesive used in the outer adhesive bands of a conventional binder strip. However, unlike a conventional binder strip, strip 64 does not include a center strip of low viscosity temperature activated adhesive, with such adhesive functioning in a conventional strip to secured the edges of the individual sheets together an to the binder strip. The binding machine operates in the same manner as with a conventional strip, applying heat and pressure to the strip so as to activate the binder strip adhesive and to secure the center region of the binder strip to the edge of the stack and to secure the outer edges of the strip to the lower portions of the end leafs 56A and 56B. Thus, a book block 10 is formed which includes the stack assembly (stack 15 and end leafs 56A/56B) together with strip 64 which is wrapped around the edge of the stack assembly to be bound. At this point the binder strip 64 functions to tack the end leafs 56A and 56B, the stack 15 and the strip itself together prior to the stitching step represented by block 70 of FIG. 21. FIG. 15 shows the stitching step being performed manually, with such operation typically being carried out using a conventional bindery side stitching machine which applies a series of spaced-apart metal staples 62 (or sewn thread). Preferably, the stitching is approximately ⅛ of an inch from the edge of the stack. FIGS. 60A and 60B are two perspective view of the bound book block 74 at this stage, with the width of the reinforcing strips 60A and 60B being exaggerated for purposes of illustration.

The next step in the sequence, as represented by block 72 of FIG. 21, is to encase the book block in a hardcover assembly. As will be explained, one aspect of the present inventions is to alter certain dimensions of the previously described prior art hardcover assembly 18 so that once the book block 74 has been encased using the hardcover guide apparatus, the stitching 62 is less visible or preferably not visible. The sequence will be described using the prior art FIGS. 7 and 8A through 83 except book block 74 will be substituted for the depicted prior art book block 10. In fact, one objective of the present invention is to allow the use of the prior art hardcover guide apparatus 40 in applying the hardcover assembly 18 to book block 74.

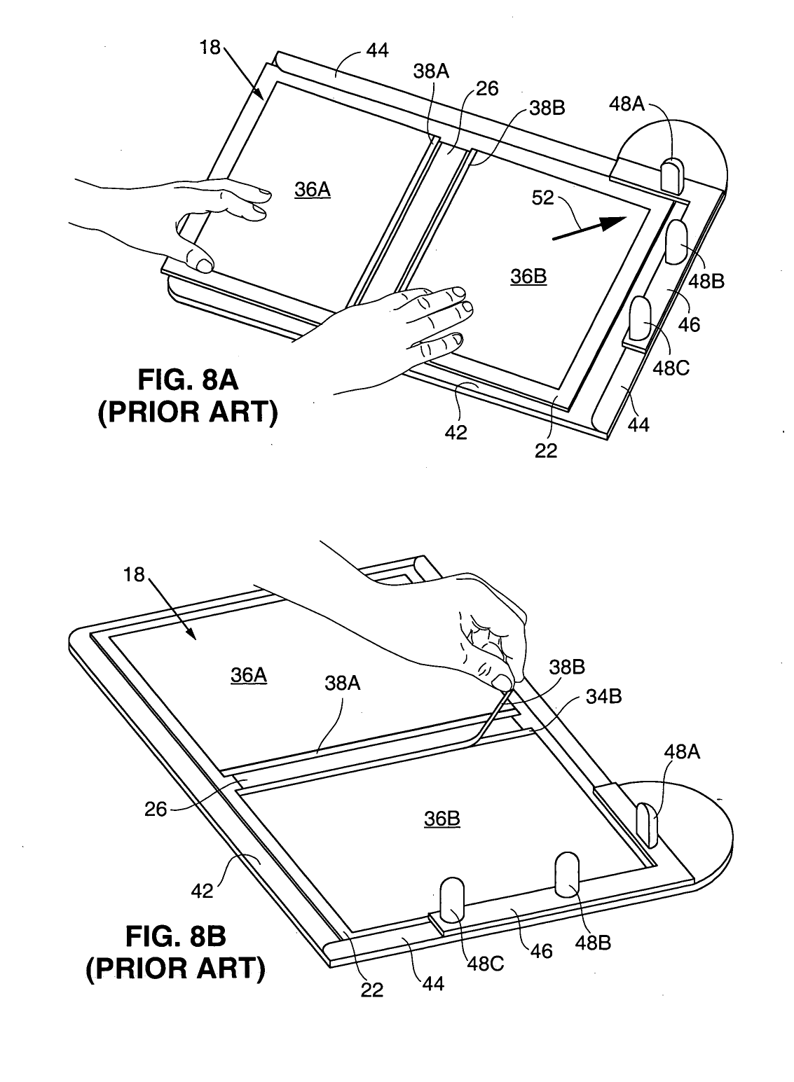

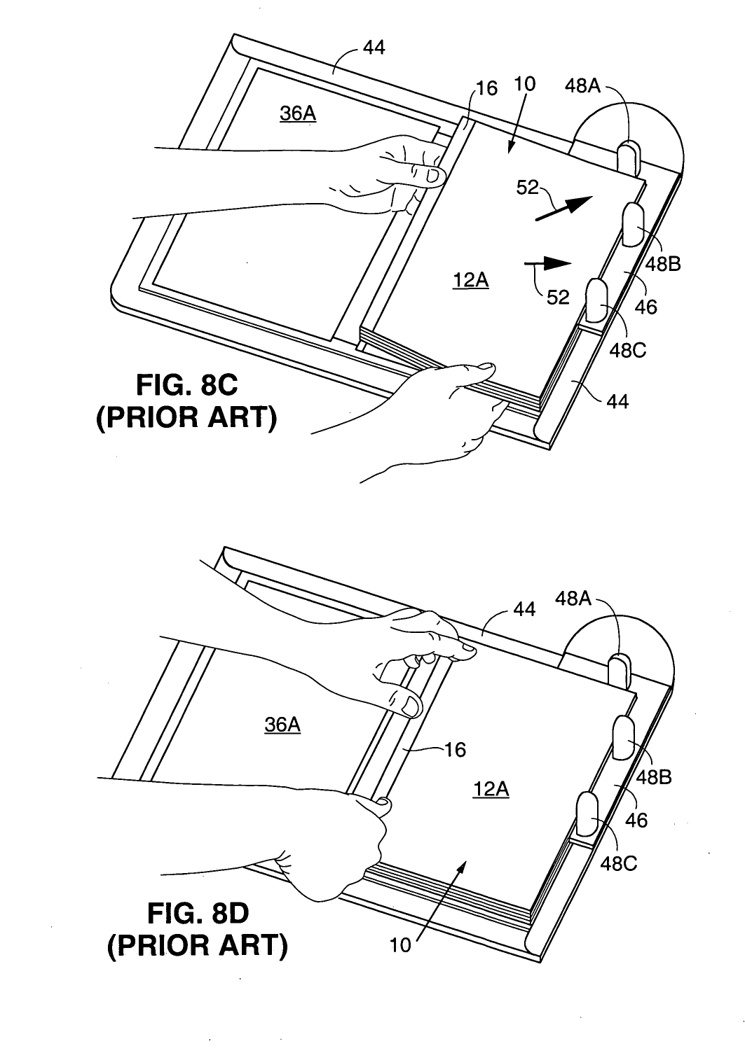

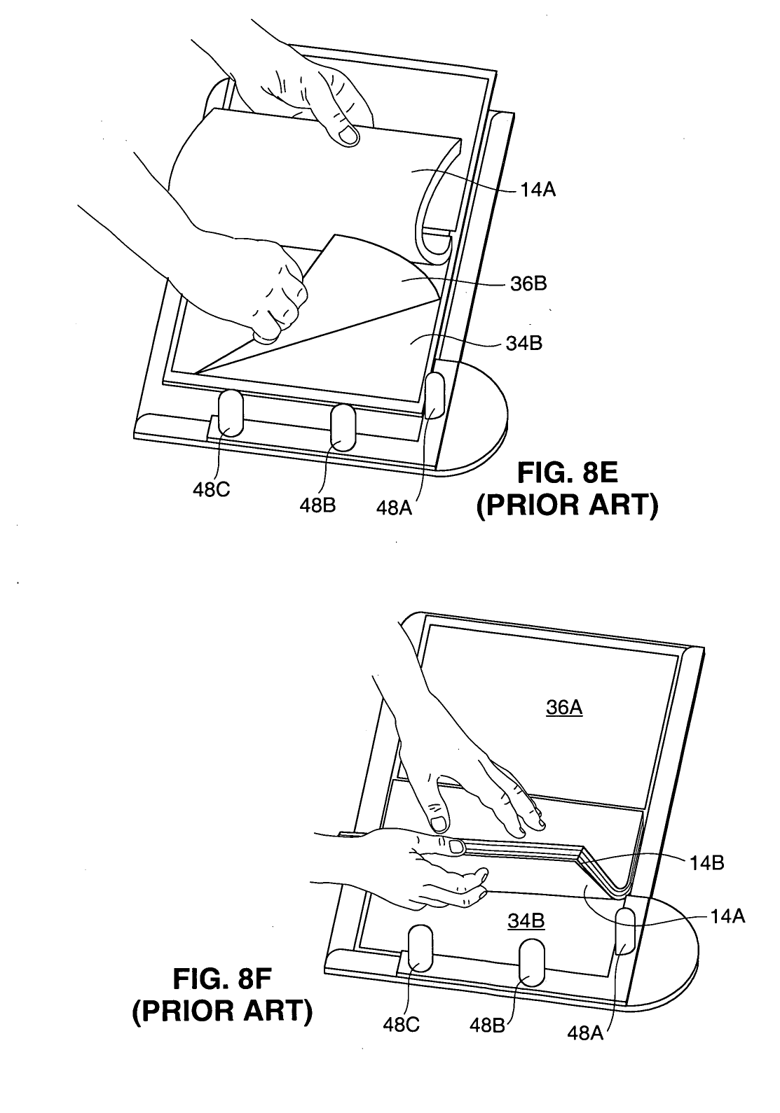

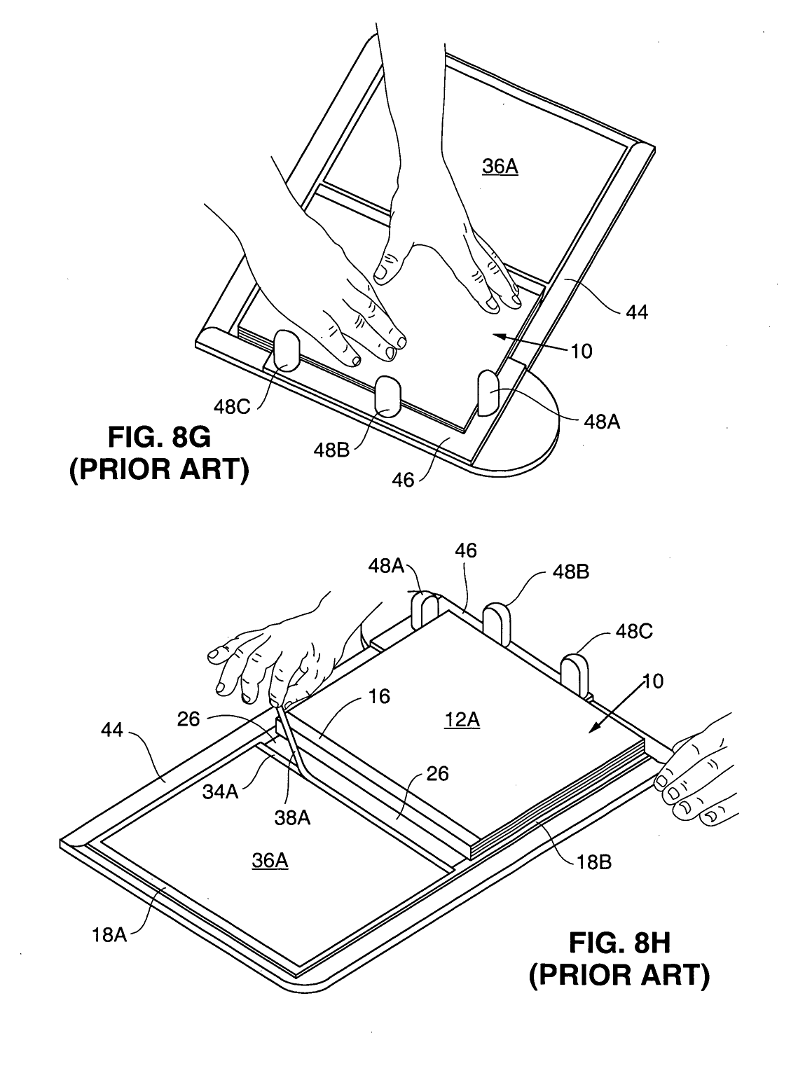

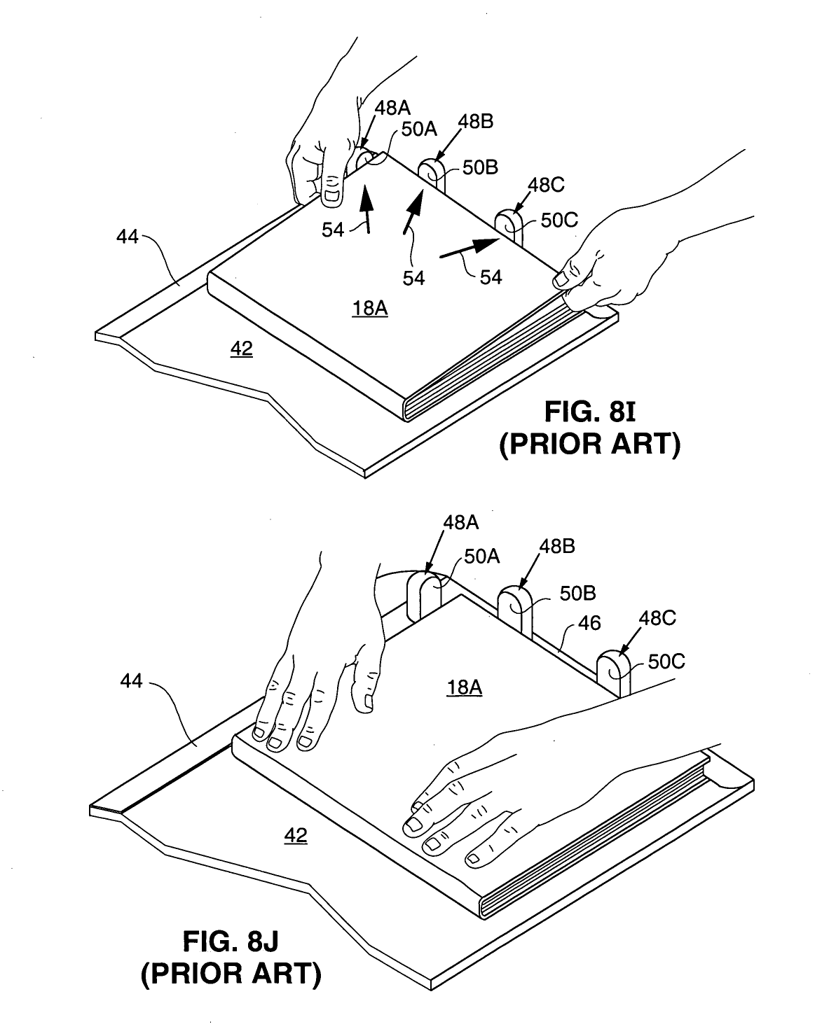

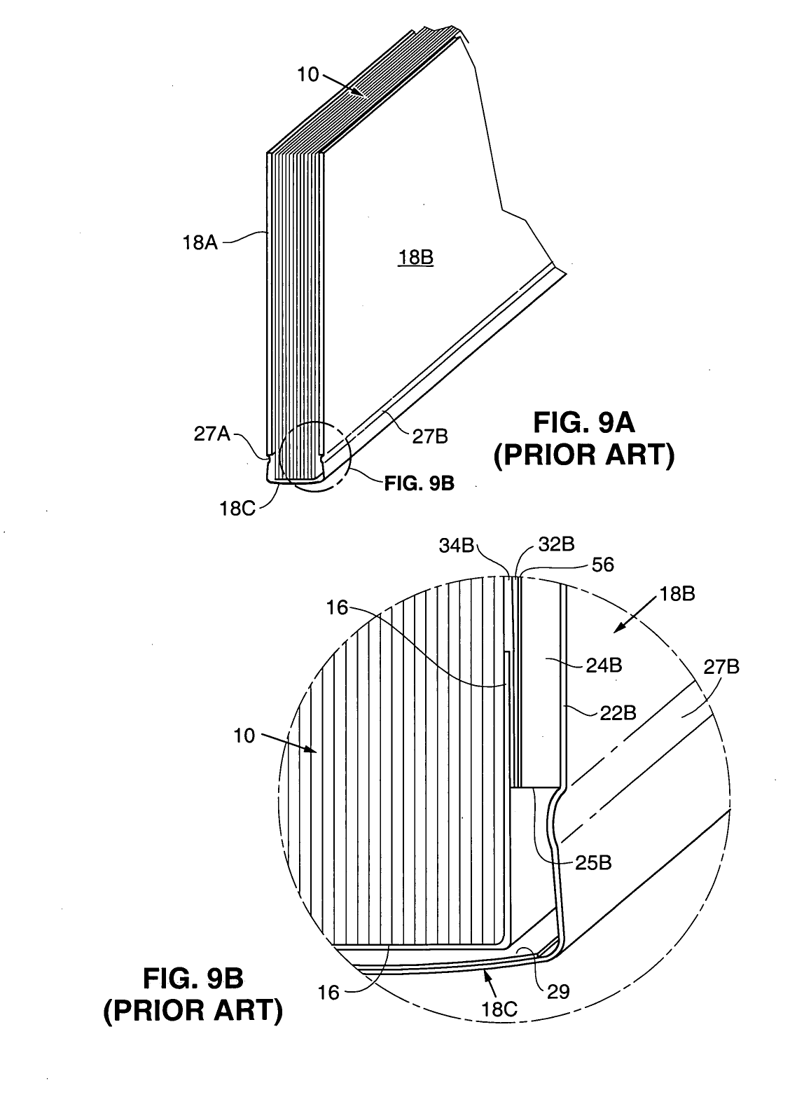

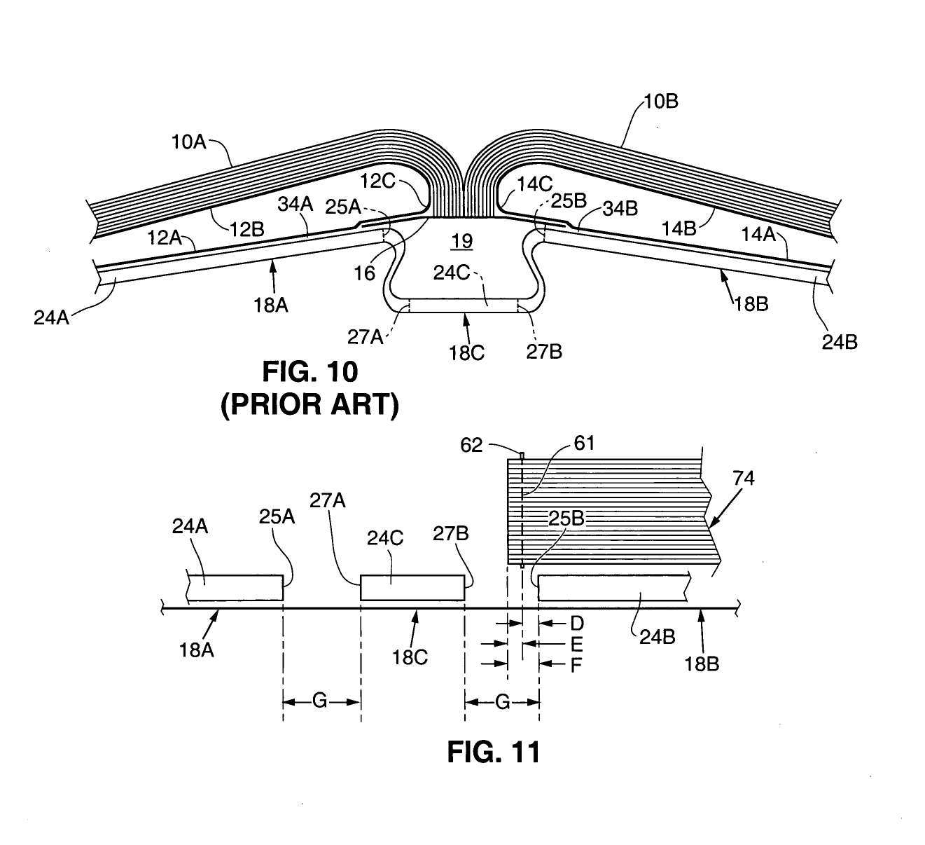

As previously described in connection with FIG. 8A, the user first positions the modified hardcover assembly, which will continue to be referred to as assembly 18 for convenience, on the prior art hardcover guide apparatus 40. The assembly 18 position is adjusted so that the edges of the hardcover assembly are contacting stop edges 44A of the orthogonal stop members as shown in FIG. 7 for one of the edges 44A. Next, the user removes minor release liner 38B so as to expose a narrow strip of the underlying pressure sensitive adhesive 34B as shown in FIG. 8B. The book block 74 is then positioned over the hardcover assembly in the same manner as the prior art book block 10 of FIGS. 8C and 8D. The edges of the book block 74 are positioned contacting outer edges of the stop members, such as outer edge 46A of stop member 44 of FIG. 7. This will cause single binder strip 64 of book block 74 to contact the narrow strip of exposed adhesive 34B thereby fixing the relative position of the book block 74 and the hardcover assembly 18 as represented by FIG. 8D.

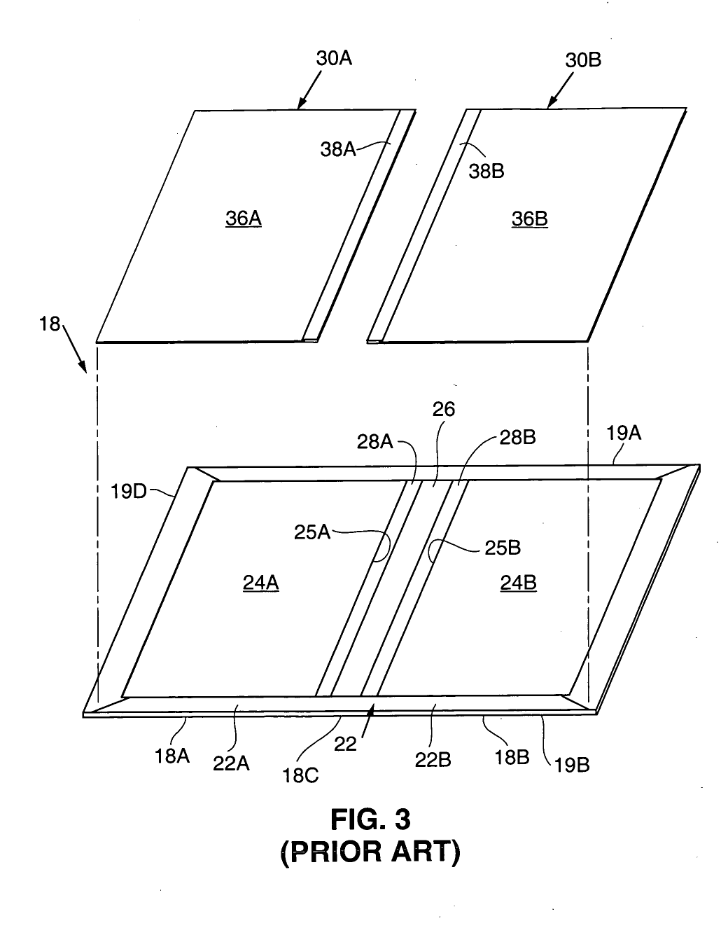

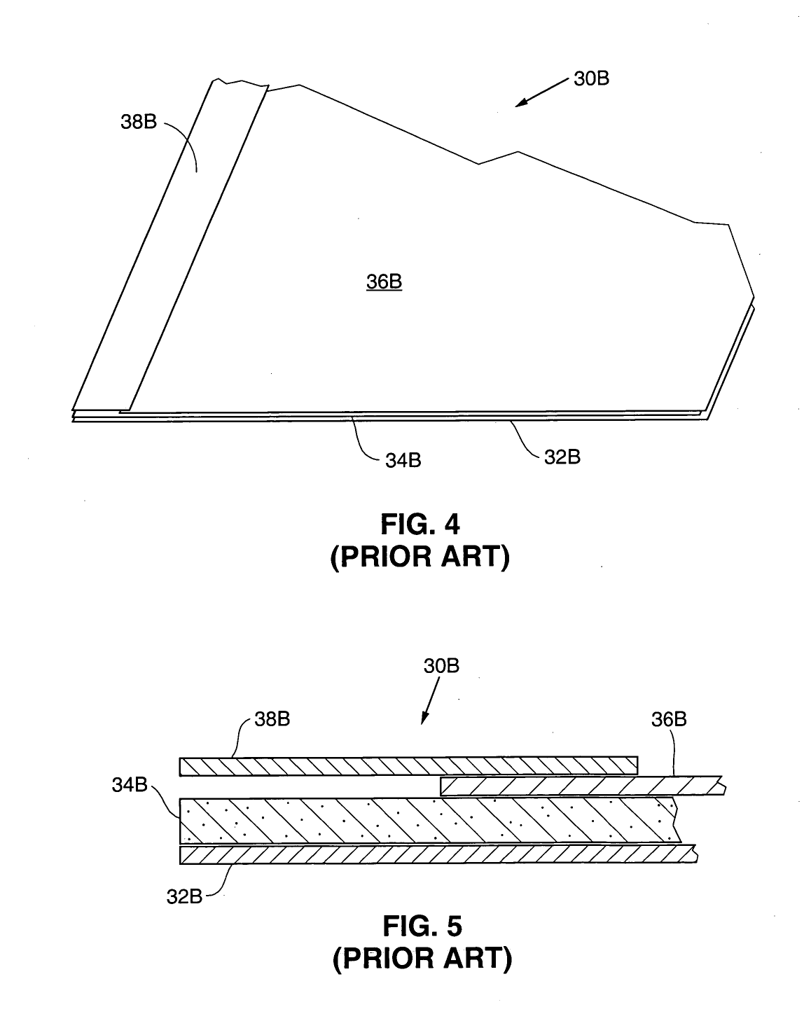

Reference is momentarily made to the simplified diagram of FIG. 11 which shows the relative position of book block 74 and key components of the hardcover assembly 18 at this stage in the sequence. A prior art rigid spine board 24C is shown over the spine section 26 as shown in FIG. 8B rather than the stiff fabric stiffening member 29 also previously described. At this point, the book block 74 is positioned over cover section 18B which includes the relatively rigid cover board 24B (FIG. 3) with the intermediate major release liner 36B and adhesive layer 34B not being depicted. The distance G, the distance between one edge 27B of spine cover board 24C and the opposite edge 25B of cover board 24B, defines one of the two gutter regions of the hardcover. Distance D represents the distance between the edge 25B of the cover board 24B and the staple line 61. Distance E represents the spacing between the end of the book block 74 and the stitch line 61 along which staples or other types of stitching 62 are disposed. Distance F is the distance between the edge 25B of the cover board 24B and the end of the book block 10/74. Note that the cover boards 24A and 24B are both covered with pressure sensitive adhesive, as described earlier, so that the location of the edges of the cover boards 25A and 25B define the location at which the opposing edges of the binder strip 14 are secured to the front and back hardcover sections 18A and 18B. Table 2 below shows a comparison, where applicable, of the values of D, E, F and G for the prior art and as the hardcover assemblies are for the present invention. The significance of these various dimensions will be subsequently described.

TABLE 2

| | D | E | F | G |
|---|---|---|---|---|
| | (inches) | (inches) | (inches) | (inches) |
| PRIOR ART | N/A | N/A | 3/16 | 7/16 |
| MODIFIED | ¼ | ⅛ | ⅜ | 9/16 |

Returning again to the binding sequence, the next step is to secure the remainder of sheet 58B of end leaf 56B to the hardcover section 18B. The user lifts the free end of book block 74 so as to provide access to the underlying major release liner 36B as shown in FIG. 8E. The release liner 36B is removed thereby exposing the remainder of the layer 34B of pressure sensitive adhesive as indicated by FIG. 8F. The book block 74 is then pressed down over the exposed adhesive so that all of sheet 58B is secured to hardcover section 18B.

Continuing, the minor release liner 38A of hardcover section 18A is then removed as shown in FIG. 8H along with the major release liner 36A thereby exposing the entire layer of pressure sensitive adhesive 34A. As shown in FIG. 8I, the user then lifts up hardcover section 18A and rotates it over the book block 74 and aligns the edges of hardcover section with stops 48A, 48B and 48C, taking care not to permit the hardcover section from contacting the exposed adhesive 34A until the alignment is completed. FIG. 7 shows the hardcover section 18A contacting one stop 48C. The user then presses down all over the surface of the hardcover section 18A as shown in FIG. 83 so that single sheet end leaf 56A is secured by adhesive 34A to the entire inner surface of the hardcover section. This completes the binding sequence.

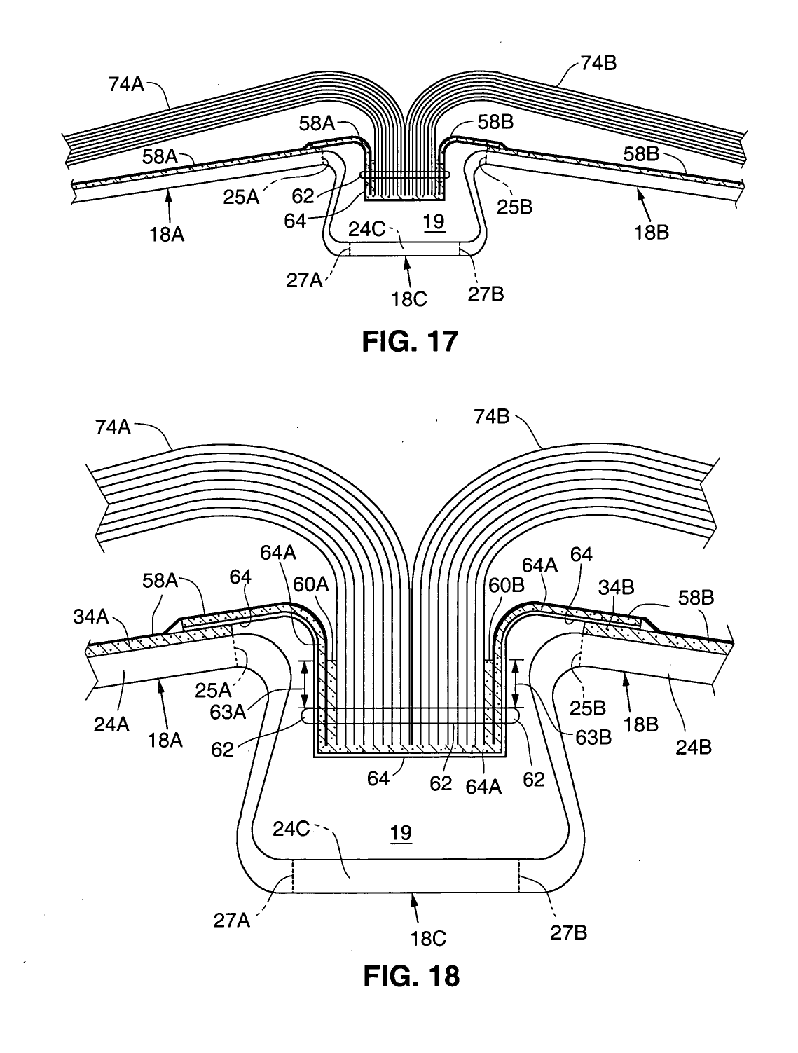

FIGS. 17 and 18 show an end view of the completed hardcover book, with the book block 74 being opened near the middle of the book to create block sections 74A and 74B. It can be seen more clearly in FIG. 18 that one edge of reinforcing binder strip 64 is secured between cover board 24A and end leaf sheet 58A by adhesive 34A, with the opposite side of the binder strip being secured between cover board 24B and end leaf sheet 58B by adhesive 34B. The reinforcing binder strip 64 is secured to the remainder of the book block primarily by staples 62, with the heat activated binder strip adhesive 64A providing additional strength. The two reinforcing strips 60A and 60B disposed on opposite side of the stack, as previously noted, reinforce the respective ends of the end leaf sheets 58A and 58B so substantially reduce any tendency of the paper leafs to be torn away from the staples 62. Further, the reinforcing strips provide distributed support for the respective end leaf sheets 58A and 58B over a significant area so that the end leafs do not form folds right at the staples 62 as would normally occur. Instead, the reinforcing strips 60A and 60B function to maintain the support provided by staples 62 in regions designated 63A/63B starting at the staples 62 and ending at the outer edges of the reinforcing strips 60A and 60B. The support in these regions is sufficient to conceal the staples 62 from view in the area intermediate book blocks 74A and 74B when the book is opened as shown in FIG. 18 and from view in the regions between the book block 74 and either sheet 58A or 58B when only one or the other of the covers is opened. This support is enhanced in that the reinforcing strips 60A and 60B are fully adhered to the respective sheets 58A and 58B so as to prevent movement of the strips 60A/B relative to the sheets 58A/B thereby reducing any tendency of the end leafs 56A/56B to bend in the region of the staples.

Note that it would be possible to reverse the orientation of each of the end leafs 56A and 56B so that the reinforcing strips 60A and 60B are no longer facing toward the stack 15 as shown in FIG. 13 but are facing away from the stack. In that event, the strips 60A and 60B would be facing the binder strip 64. Also, although it has been found that reinforcing strips made of adhesives are preferred, other materials sufficient to add the requisite rigidity to the end leafs 56 could be used such as paper and the like.

FIG. 22 is a simplified schematic diagram of certain components of a book bound in accordance with one embodiment of the present invention. The front and back hardcover sections 18A and 18B are disposed in a common plane as would typically occur when the book is opened. The book block 74 is attached to the respective cover sections 18A and 18B by way of respective connecting structures 76A and 76B. Connecting structure 76A represents the combined structure provided by one side of binder strip 64 and sheet 58A of end leaf 56A which function together to secure the book block 74 to hardcover section 18A. Connecting structure 76B represents the combined structure provided by the other side of binder strip 64 and sheet 58B of end leaf 56B which function together to secure book block 74 to hardcover section 18B. The connecting structures 76A and 76B are effectively secured to the book block at respective locations 78A and 78B so that when the cover sections 18A and 18B are placed in a common plane, the stitch line is disposed below the plane thereby making the stitching completely invisible or, at minimum, less visible. As previously described in connection with FIG. 18, the presence of the reinforcing strips 60A and 60B functions, among other things, to increase the distance between the effective connecting points 78A/B from the stitching line 61. Note that the visibility of the staple 62 is eliminated or reduced under normal usage, but it is apparent that an unduly large force applied to the cover sections 18A and 18B would be able to overcome the rigidity provided by the reinforcing strips 60A/B and thus defeat the advantages provided the strips. It is, however, undesirable to use overly rigid reinforcing strips since such strips would tend to interfere with binding and would conceivable detract from the appearance of the bound book.

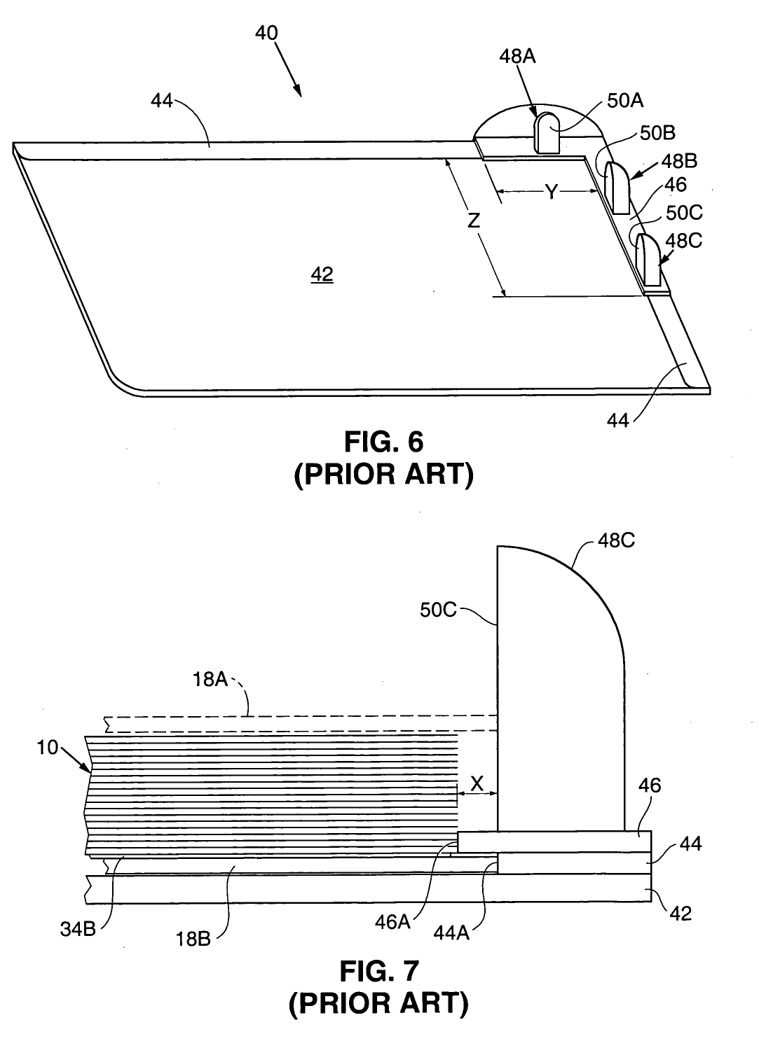

Table 2 above shows certain dimensions of the modified hardcover assembly relative to the book block in accordance with one aspect of the present invention as compared to the prior art. As previously noted, one objective of selecting the dimensions is to permit a common hardcover guide apparatus 40 (FIG. 6) to be used for both prior art hardcover assemblies and the modified hardcover assemblies as disclosed herein. Referring to FIG. 11 together with Table 2, it can be seen that book blocks are typically stitched ⅛ of an inch from the end as indicated by dimension E. The width G of the gutters, which is the spacing between the respective cover boards 24A and 24B and the spine board 24C is increased from the prior art value of 7/16 of an inch to 9/16 of an inch. Note that the width of the spine board 18C remains unchanged for a given range of stack thicknesses as indicated by Table 1, with the spine width 26 entries also corresponding to the spine board 18C widths for a give stack thickness.

Distance F of FIG. 11 and Table 2 essentially defines the location where the binder strip 64 first attaches to the cover boards at edges 25A and 25B of the cover boards as shown in FIG. 18. These edges are also the main pivot points of the cover as the book opens. Note that to enable the distance F between the end of the cover boards and the end of the book block to be increased by an amount of 3/16 of an inch from 3/16 of an inch to ⅜ of an inch, the width G of the gutters are each increased by an amount of ⅛ of an inch from 7/16 of an inch to 9/16 of an inch. Since a common guide apparatus 40 is preferably used, narrowing the total overall width of each of the cover boards by 3/16 of an inch, as compared to the prior art boards, compensates for the additional ⅛ of an inch gutter and aligns the book block 74 a distance of 1/16 of an inch deeper in the gutter G. The increase in spacing between the respective edges 25A and 25B of the cover boards increases the distance from the point at which the connecting structure 76A connects to the cover board at edge 25A to the book block connecting point 78A (FIG. 22) and increases the distance from the point at which connecting structure 76B connects to the cover board at edge 25B to the book block connecting point 78B. This forces the book block 74 to drop deeper into the spine cavity 19 (FIG. 18) so that the staples are below connecting points 78A and 78B. Thus, the binding staples are below the plane of the book covers 24B and 25B when the covers are open and remain recessed from view, without tearing the end leaf material.

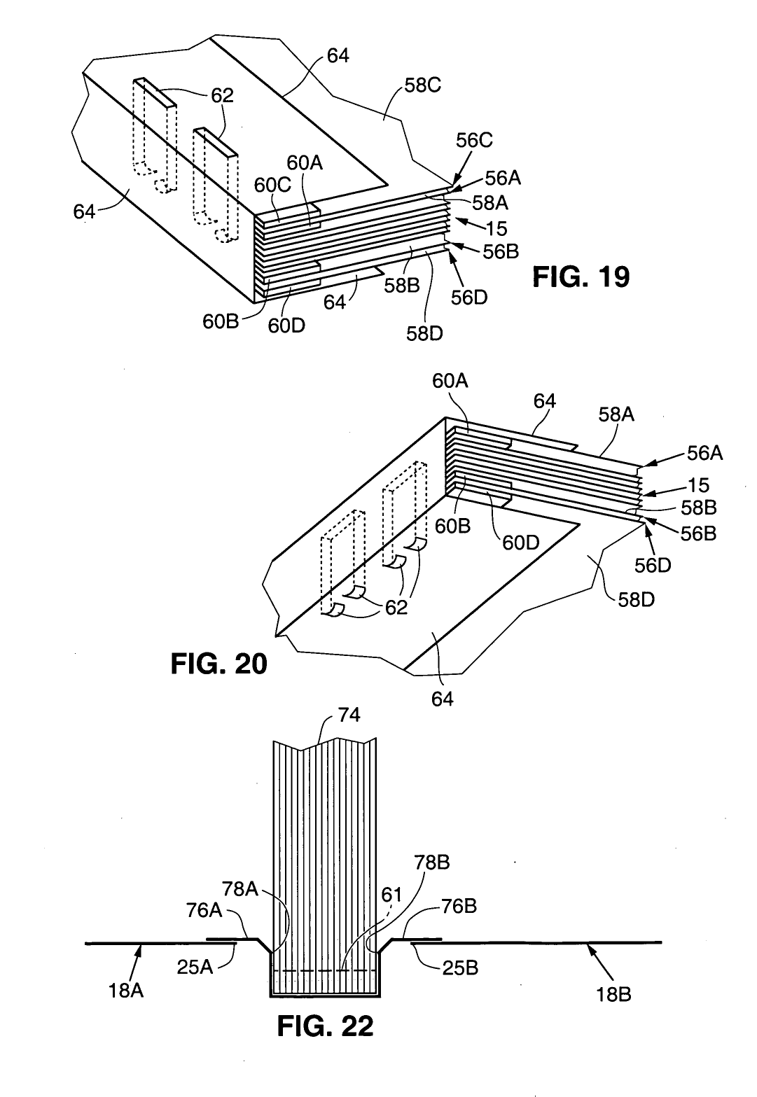

FIGS. 14 and 19 show a further embodiment of a hardcover book in accordance with the present invention. Instead of a pair of single sheet end leafs, a total of four such end leafs are used. As can be seen in FIG. 14, a pair of end leafs 56A and 56C are disposed on one side of the stack 15 to be bound, with another pair 56B and 56D being disposed on the other side of the stack. The entire assembly is then placed in a binding machine, as described in connection with the previous embodiment, so that the assembly is bound with a binder strip 64. The resultant book block is then stitched as shown in FIGS. 15 and 19. Finally the stitched book block is encased in a hardcover as previously described, with outside end leaf sheets 58C and 58D being attached to the hardcover sections 18A and 18B by respective pressure sensitive adhesive layers 34A and 34B. The remaining two end leafs 56A and 56B then function as attractive first and last pages of the bound book with, for example, all of the four end leafs 56A, 56B, 56C and 56C having the same distinctive color. Alternate decorative colors could also be used for the first and last pages. The reinforcing adhesive strips of inner end leafs 56A and 56B, strips 60A and 60B, add to the reinforcing action provided by strips 60C and 60D.

FIG. 20 shows a third embodiment using three single sheet end leafs, including leaf 56A on one side of the stack and a pair of end leafs 56B and 56D on the other side of the stack. The first page of the book stack may also use a decorative velum sheet next to under leaf 56A to enhance the appearance of the book and protect the image page. The book is bound and encased as previously described in connection with the previous two embodiments, with end leafs 56A and 56D being secured to the respective hardcover sections 18A and 18B and with leaf 56B functioning as an attractive last page to enhance the appearance of the bound book and to further reinforce the book in the staple region.

Thus, various embodiments of a novel bound hardcover book have been disclosed along with a method of making the books. Although these embodiments have been described in some detail, it should be noted that persons skilled in the relevant art can make changes without departing from the spirit and scope of the present invention as defined by the appended claims.

What is claimed is:

1. A hardcover book comprising:
a hardcover assembly including first and second relatively rigid cover sections separated by a spine section;
a stack of sheets;
first and second end leafs, with each of the end leafs including an attached reinforcing strip extending along an edge of the end leaf, with the stack of sheets being disposed intermediate the end leafs, with the end leafs and the stack forming a stack assembly and with the reinforcing strips located near an edge of the stack assembly to be bound;
stitching extending through the stack and the reinforcing strips, with said stitching being disposed along a stitching line on the edge of the stack assembly, with the stitching line being substantially parallel to the edge of the stack assembly to be bound, with said first end leaf being secured to an inner surface of the first cover section and with said second end leaf being secured to an inner surface of the second cover section; and
wherein, with said first and second cover sections positioned in a common plane, a bound end of the sheets of the stack is disposed on a first side of the common plane, with the sheets extending to an opposite second side of the common plane and with the stitching line being disposed on said first side of the plane.

2. The hardcover book of claim 1 wherein the reinforcing strips of the first and second end leaf include an adhesive.

3. The hardcover book of claim 2 wherein the reinforcing strip of the first end leaf is disposed in the stack assembly contacting a first outer sheet of the stack, with the adhesive of the reinforcing strip functioning to secure the first end leaf to the first outer sheet in a region of the stitching and wherein the reinforcing strip of the second end leaf is disposed in the stack assembly contacting a second outer sheet of the stack, with the adhesive of the reinforcing strip functioning to secure the second end leaf to the second outer sheet in a region at the stitching.

4. The hardcover book of claim 2 wherein the first and second outer sheets of the stack of sheets comprise respective third and fourth end leafs, each being substantially a same size as the sheets, with each of the third and fourth end leafs including an attached reinforcing strip extending along an edge of the end leaf with the stitching also extending through the reinforcing strips of the third and fourth end leafs.

5. The hardcover book of claim 1 further comprising an elongated binder strip wrapped around the edge of the of the stack assembly, with binder strip including a first side portion facing the first end leaf, a second side portion facing the second end leaf and a spine portion intermediate the first and second side portions and facing the edge of the stack assembly to be bound, with said stitching extending through the first and second side portions of the binder strip.

6. The hardcover book of claim 5 wherein the first side portion of the binder strip extends from the stack assembly and is attached to the first cover section and the second side portion of the binder strip extends from the stack assembly is attached to the second cover section.

7. The hardcover book of claim 6 wherein the first side portion extends intermediate the first cover section of the hardcover assembly and the first end leaf and wherein the second side portion extends intermediate the second cover section of the hardcover assembly and the second end leaf.

8. The hardcover book of claim 7 wherein the binder strip includes a layer of heat activated adhesive on at least the first and second side portions that contact the respective first and second end leafs.

9. A hardcover book comprising:
a hardcover assembly including first and second relatively rigid cover sections separated by a spine section;
a stack of sheets;
first and second end leafs, with each of the end leafs including an attached reinforcing strip extending along an edge of the end leaf, with the stack of sheets being disposed intermediate the end leafs, with the stack and end leafs forming a stack assembly, with the reinforcing strips located near an edge of the stack assembly to be bound;
an elongated binder strip wrapped around the edge of the stack assembly to be bound, said binder strip including a first side portion facing the first end leaf and a second side portion facing the second end leaf;
stitching extending through the stack, the reinforcing strips and the first and second side portions of the binder strip, with said stitching being disposed along a stitching line on the edge of the stack assembly, with the stitching line being substantially parallel to the edge of the stack assembly to be bound; and
wherein the first end leaf extends away from the edge of the stack assembly and is attached to an inner surface of the first cover section of the hardcover assembly and the second end leaf extends away from the edge of the stack assembly and is attached to an inner surface of the second cover section of the hardcover assembly and wherein the first side portion of the binder strip extends away from the edge of the stack assembly and is disposed intermediate the first cover section and the first end leaf and the second side portion of the binder strip extends away from the edge of the stack assembly and is disposed intermediate the second cover section and the second end leaf.

10. The hardcover book of claim 9 wherein the reinforcing strips of the first and second end leafs are each comprised of adhesive.

11. The hardcover book of claim 10 wherein the reinforcing strip of the first end leaf is disposed in the stack assembly contacting a first outer sheet of the stack, with the adhesive of the reinforcing strip functioning to secure the first end leaf to the first outer sheet in a region of the stitching and wherein the reinforcing strip of the second end leaf is disposed in the stack assembly contacting a second outer sheet of the stack, with the adhesive of the reinforcing strip functioning to secure the second end leaf to the second outer sheet in a region at the stitching.

12. A method of binding a stack of sheets to form a hardcover book comprising;
providing a hardcover assembly including first and second relatively rigid cover sections separated by a spine section;
forming a stack assembly by disposing the stack of sheets between first and second end leafs, with each of the end leaf including an attached reinforcing strip extending along an edge of the stack assembly to be bound;
wrapping an elongated binder strip around the edge of the stack assembly so that a first side portion of the binder strip is facing a first side of the stack assembly and so that a second side portion of the binder strip, opposite the first portion, is facing a second side of the stack assembly;
stitching the stack assembly along a stitching line generally parallel to the edge of the stack assembly to be bound, with the stitching extending though the first and second side portions of the binder strip, through the reinforcing strips of the end leafs and through the stack of sheets;
subsequent to the stitching, attaching the first end leaf to the first cover section of the hardcover assembly; and
subsequent to the stitching, attaching the second end leaf to the second cover section of the hardcover assembly.

13. The method of claim 12 wherein, subsequent to the stitching, attaching the first side portion of the binder strip to the first cover section and attaching the second side portion of the binder strip to the second cover section.

14. The method of claim 13 wherein part of the first side portion of the binder strip is disposed intermediate the first cover section and the first end leaf and-wherein part of the second side portion of the binder strip is disposed intermediate the second cover section and the second end leaf.

15. The method of claim 14 wherein the elongated binder strip includes temperature activated adhesive at least on the first and second portions of the binding strip and the wrapping an elongated binder strip includes applying heat and pressure to the binder strip so that the binder strip is attached to the stack assembly by the adhesive on the binder strip.

16. The method of claim 12 wherein the reinforcing strips are substantially adhesive.

17. A hardcover book comprising:
a hardcover assembly including first and second relatively rigid cover sections separated by a spine section;
a stack of sheets;
a first end leaf disposed on a first side of the stack of sheets;
a second end leaf disposed on a second side, opposite the first side, of the stack of sheets;
a first reinforcing member being disposed on the first side of the stack of sheets, with at least a first region of the first reinforcing member being adhered to the first end leaf;
a second reinforcing member disposed on a second side of the stack of sheets, with at least a first region of the second reinforcing member being adhered to the second end leaf;
stitching extending through said stack of sheets, said first and second end leafs and said first and second reinforcing members at said respective first regions; and
wherein said first end leaf extends away from the stack and is attached to the first cover section and with the first reinforcing member being positioned to reinforce at least a portion of the first end leaf intermediate the stitching and the first cover section and wherein said second end leaf extends away from the stack and is attached to the second cover section and with the second reinforcing member being positioned to reinforce at least a portion of the second end leaf intermediate the stitching and the second cover section.

18. The hardcover book of claim 17 where said first and second reinforcing members are each comprised substantially of adhesive.

19. The hardcover book of claim 17 wherein the stack of sheets and first and second end sheets are bound using a binder strip which includes an heat activated adhesive, with the stitching extending through first and second opposite sides of the binder strip.

20. The hardcover of claim 19 wherein the first side of the binder strip is attached to the first cover section and the second side of the binder strip is attached to the second cover section.
